(19) United States
(12) Patent Application Publication
(10) Pub. No.: US 2016/0314755 A1
(43) Pub. Date: Oct. 27, 2016

(54) REGULATING SYSTEM, REGULATING METHOD, AND DISPLAY DEVICE

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Xia FENG, Beijing (CN); Jiacheng HUANG, Beijing (CN)

(21) Appl. No.: 15/091,806

(22) Filed: Apr. 6, 2016

(30) Foreign Application Priority Data
Apr. 24, 2015 (CN) 201510205153.4

(51) Int. Cl. G09G 3/36

(52) U.S. Cl. CPC G09G 3/3696; G09G 3/3655; G09G 2320/045; G09G 2320/0247

(57) ABSTRACT

The invention provides a regulating system, a regulating method and a display device. The regulating system is used for regulating a common voltage of a liquid crystal display panel and includes a correction unit and a regulating unit, wherein the correction unit is used for detecting a flicker value of the liquid crystal display panel, determining whether the flicker value satisfies a requirement, and sending a regulating control signal to the regulating unit according to a determination result, and the regulating unit is used for regulating the common voltage according to the regulating control signal and providing the regulated common voltage to the liquid crystal display panel. The regulating system can automatically regulate the common voltage of the liquid crystal display panel, so that flicker phenomenon, due to drift in characteristics of the liquid crystal display panel, is alleviated or avoided.

### CROSS-REFERENCE TO RELATED APPLICATION

This application claims priority to Chinese Patent Application No. 201510205153.4, filed on Apr. 24, 2015, the contents of which are incorporated by reference in the entirety.

### FIELD OF THE INVENTION

The present invention belongs to the field of display technology, and particularly relates to a regulating system, a regulating method, and a display device including the regulating system.

### BACKGROUND OF THE INVENTION

With development of display technology and progress of the society, liquid crystal display technology has been more and more widely applied and played an important role in industrial production and people's life.

A current liquid crystal display device generally includes a timing controller, a power supply circuit, a gamma voltage generation circuit, a common voltage regulating circuit, a source driver, a gate driver and a liquid crystal panel. The liquid crystal panel includes a plurality of pixels each including a thin film transistor (TFT) and a pixel capacitor (including a storage capacitor and a liquid crystal capacitor), one end of the pixel capacitor is connected to the source of the TFT, and the other end thereof is connected to a common electrode. All of the common electrodes on the liquid crystal panel are connected together and are connected to an output terminal of the common voltage regulating circuit.

When the TFT of the pixel is turned on, the storage capacitor starts to charge, and causes liquid crystal molecules to deflect after charging to a certain voltage, and the deflected liquid crystal molecules can allow light having a certain brightness to pass therethrough, so as to achieve different grayscales displayed by the pixels. However, the liquid crystal molecules may be polarized if they are always deflected in one direction, thereby destroying the characteristics thereof. Therefore, it is necessary to adopt signal voltages alternating between positive signal voltage and negative signal voltage to drive the liquid crystals. In a case where a voltage (thereinafter referred to as pixel voltage) applied to the pixel electrode is higher than a voltage (thereinafter referred to as common voltage) applied to the common electrode, the pixel voltage is referred to as a positive signal voltage, and in a case where the pixel voltage is lower than the common voltage, the pixel voltage is referred to as a negative signal voltage. In the process of alternate driving with positive signal voltage and negative signal voltage, if the difference between values of the positive signal voltage and the common voltage greatly differs from that between values of the negative signal voltage and the common voltage, a relatively large difference exists in the display of two adjacent frames in the case of a display brightness of the same grayscale, and visually, screen flicker occurs.

In order to avoid flicker, the common voltage needs to be regulated. In conventional regulating methods, the common voltage is generally manually regulated with a mechanical voltage regulator VR or a digital voltage regulator DVR, and the manual regulation is a one-time operation and performed before delivery of liquid crystal panels. However, the regulating methods suffer disadvantages such as low efficiency, poor reliability and inferior image quality.

### SUMMARY OF THE INVENTION

In view of the above technical problems existing in the prior art, the present disclosure provides a regulating system, a regulating method and a display device. The regulating system can automatically regulate a common voltage of a liquid crystal display panel, so that flicker phenomenon, due to drift in characteristics of the liquid crystal display panel, is alleviated or avoided, and image quality is improved; meanwhile, regulating efficiency and regulating quality of the common voltage of the liquid crystal display panel are improved as well.

In one aspect, the present disclosure provides a regulating system for regulating a common voltage of a liquid crystal display panel, including a correction unit and a regulating unit, wherein the correction unit is used for detecting a flicker value of the liquid crystal display panel, determining whether the flicker value satisfies a requirement, and sending a regulating control signal to the regulating unit according to a determination result, and the regulating unit is used for regulating the common voltage according to the regulating control signal and providing the regulated common voltage to the liquid crystal display panel.

Optionally, the correction unit includes a setting module, a detection image output module, a detecting element, a determining module and a control module, wherein:

the setting module is used for setting a flicker value acceptable range for the liquid crystal display panel;

the detection image output module is used for outputting, to the liquid crystal display panel, a detection image signal for detecting the flicker value of the liquid crystal display panel to cause the liquid crystal display panel to display a detection image;

the detecting element is used for detecting the flicker value of the liquid crystal display panel, and sending the flicker value to the determining module;

the determining module is used for determining whether the flicker value is in the flicker value acceptable range and sending the determination result to the control module; and

the control module is used for sending the regulating control signal to the regulating unit when the determination result of the determining module is negative.

Optionally, the correction unit further includes a reminder module used for sending, under the control of the control module, a reminder signal of placing the detecting element at a to-be-detected position of the liquid crystal display panel after the detection image output module has outputted the detection image signal to the liquid crystal display panel.

Optionally, the regulating unit includes a switch module, an upward regulating module, a downward regulating module and an output module, wherein,

the switch module is used for switching between the upward regulating module and the downward regulating module upon receipt of the regulating control signal;

the upward regulating module is used for regulating the common voltage upwardly, and sending the regulated common voltage to the output module;

the downward regulating module is used for regulating the common voltage downwardly, and sending the regulated common voltage to the output module; and

the output module is used for outputting the regulated common voltage to the liquid crystal display panel.

Optionally, the correction unit further includes a recording module and a comparison module, wherein, the recording module is used for recording the flicker value under the control of the control module if the determination result of the determining module is negative; and the comparison module is used for comparing a deviation of a re-detected flicker value detected by the detecting element after the liquid crystal display panel has received the regulated common voltage outputted from the output module from the flicker value acceptable range with a deviation of a previously-detected flicker value recorded by the recording module from the flicker value acceptable range, and sending a comparison result to the determining module, when the determining module determines that the re-detected flicker value is still out of the flicker value acceptable range;

the determining module is further used for determining, according to the comparison result, whether the re-detected flicker value is better than the previously-detected flicker value, and sending a determination result to the control module, and the control module is further used for sending a switch control signal to the switch module when the determination result is negative; and

the switch module is used for switching from the current upward regulating module to the downward regulating module, or switching from the current downward regulating module to the upward regulating module, under the control of the switch control signal.

Optionally, the regulating unit is a digital common voltage regulating chip arranged outside the liquid crystal display panel, or a common voltage control register arranged in a source driving chip.

In another aspect, the present disclosure provides a regulating method for regulating a common voltage of a liquid crystal display panel, including steps of: detecting a flicker value of the liquid crystal display panel; determining whether the flicker value satisfies a requirement; regulating the common voltage according to a determination result, and providing the regulated common voltage to the liquid crystal display panel.

Optionally, the regulating method may include:

step S1: setting a flicker value acceptable range for the liquid crystal display panel, and outputting, to the liquid crystal display panel, a detection image signal for detecting the flicker value of the liquid crystal display panel to cause the liquid crystal display panel to display a detection image;

step S2: detecting the flicker value of the liquid crystal display panel; and

step S3: determining whether the flicker value is within the flicker value acceptable range, if yes, stop regulating; if no, proceed to step S4: regulating the common voltage upwardly or downwardly, and providing the regulated common voltage to the liquid crystal display panel.

Optionally, step S4 further includes: recording the flicker value, and then steps S2 and S3 are performed again after performing step S4, if it is determined that a re-detected flicker value is still out of the flicker value acceptable range, proceed to step S5: comparing a deviation of the re-detected flicker value from the flicker value acceptable range with a deviation of the recorded previously-detected flicker value from the flicker value acceptable range, and determining, according to a comparison result, whether the re-detected flicker value is better than the previously-detected flicker value, if yes, proceed to step S4, and then return back to step S2; if no, proceed to step S6: switching from upward regulation currently performed on the common voltage to downward regulation, or switching from downward regulation currently performed on the common voltage to upward regulation, then proceed to step S4, and then return back to step S2.

Optionally, if the deviation of the re-detected flicker value from the flicker value acceptable range is smaller than that of the previously-detected flicker value from the flicker value acceptable range, it is determined that the re-detected flicker value is better than the previously-detected flicker value; otherwise, it is determined that the re-detected flicker value is not better than the previously-detected flicker value.

Optionally, after step S1 and before step S2, the regulating method further includes: sending a reminder signal of detecting a to-be-detected position of the liquid crystal display panel.

In still another aspect, the present disclosure provides a display panel including any one of the above regulating systems.

The beneficial effects of the present disclosure are as follows.

In the regulating system provided by the present disclosure, with the correction unit and the regulating unit, the regulating system can automatically regulate the common voltage of a liquid crystal display panel, so that flicker phenomenon, due to drift in characteristics of the liquid crystal display panel, is alleviated or avoided, and image quality is improved; meanwhile, compared to the prior art, regulating efficiency and regulating quality of the common voltage of the liquid crystal display panel are improved as well.

With the regulating method provided by the present disclosure, automatic regulation of a common voltage of a liquid crystal display panel can be achieved, as a result, regulating efficiency of the common voltage of the liquid crystal display panel is greatly improved, and meanwhile regulating accuracy of the common voltage is improved as well.

In the display device provided by the present disclosure, by adopting the above regulating system, automatic regulation of a common voltage therein is achieved, as a result, flicker phenomenon, due to drift in characteristics of the liquid crystal display panel, is alleviated or avoided, and display quality of the display device is improved.

### BRIEF DESCRIPTION OF THE DRAWINGS

FIG. 1 is a block diagram of a regulating system provided by an embodiment of the present disclosure; and

FIG. 2 is a flowchart of a regulating method provided by an embodiment of the present disclosure,

### DETAILED DESCRIPTION OF THE EMBODIMENTS

In order that those skilled in the art can better understand the technical solutions of the present disclosure, a regulating system, a regulating method and a display device provided by the present disclosure will be further described in detail below in conjunction with the accompanying drawings and specific embodiments.

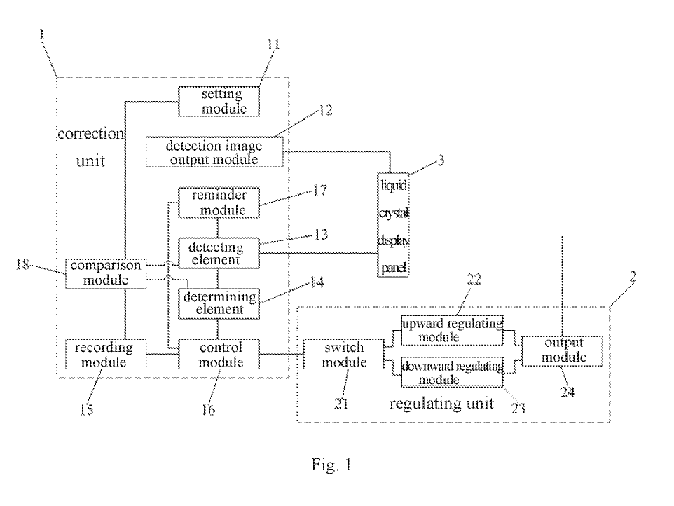

The present disclosure provides a regulating system for regulating a common voltage of a liquid crystal display panel 3. As shown in FIG. 1, the regulating system includes a correction unit 1 and a regulating unit 2. The correction unit 1 is used for detecting a flicker value of the liquid crystal display panel 3, determining whether the flicker value satisfies a requirement, and sending a regulating control signal to the regulating unit 2 according to a determination result. The regulating unit 2 is used for regulating the common voltage according to the regulating control signal and providing the regulated common voltage to the liquid crystal display panel 3.

With the correction unit 1 and the regulating unit 2, the regulating system can automatically regulate the common voltage of the liquid crystal display panel 3, so that flicker phenomenon, due to drift in characteristics of the liquid crystal display panel 3, is alleviated or avoided, and image quality is improved; meanwhile, compared to the prior art, regulating efficiency and regulating quality of the common voltage of the liquid crystal display panel 3 are improved as well.

In some embodiments, the correction unit 1 may include a setting module 11, a detection image output module 12, a detecting element 13, a determining module 14 and a control module 16. The setting module 11 is used for setting a flicker value acceptable range for the liquid crystal display panel 3. Within the flicker value acceptable range, images displayed on the liquid crystal display panel 3 have good quality and there is no need to regulate the common electrode. The detection image output module 12 is used for outputting, to the liquid crystal display panel 3, a detection image signal for detecting the flicker value of the liquid crystal display panel 3, so as to cause the liquid crystal display panel 3 to display a detection image. In the process of detecting the flicker value of the liquid crystal display panel 3, the liquid crystal display panel 3 needs to display a specific detection image, because the flicker value of the liquid crystal display panel 3 can be detected more accurately only when a specific detection image is displayed. The detecting element 13 is used for detecting the flicker value of the liquid crystal display panel 3 and sending the flicker value to the determining module 14. In some embodiments, the detecting element 13 may be a detecting pen. The detecting pen is connected to the determining module 14, can detect the flicker value of the liquid crystal display panel 3 after being placed at a to-be-detected position of the liquid crystal display panel 3, and further sends the detected flicker value to the determining module 14. The determining module 14 is used for determining whether the flicker value is in the flicker value acceptable range and sending a determination result to the control module 16. The control module 16 is used for sending a regulating control signal to the regulating unit 2 when the determination result of the determining module 14 is negative.

With the determining module 14, the regulating system can automatically determine whether the flicker value of the liquid crystal display panel 3 is in the optimal state, so that the regulating unit 2 can automatically regulate the common voltage of the liquid crystal display panel 3, which further makes the regulating system more intelligent and improves regulating efficiency of the regulating system.

In some embodiments, the correction unit 1 may further include a reminder module 17 used for sending, under the control of the control module 16, a reminder signal of placing the detecting element 13 at the to-be-detected position of the liquid crystal display panel 3 after the detection image output module 12 has outputted the detection image signal to the liquid crystal display panel 3. The reminder signal may be an audio signal or a text signal, or may be an image signal, that is, the reminder module 17 may be any device capable of sending out a reminder signal such as a buzzer or a display.

In some embodiments, the regulating unit 2 may include a switch module 21, an upward regulating module 22, a downward regulating module 23 and an output module 24. The switch module 21 is used for switching between the upward regulating module 22 and the downward regulating module 23 upon receipt of the regulating control signal. The upward regulating module 22 is used for regulating the common voltage upwardly, and sending the regulated common voltage to the output module 24. The downward regulating module 23 is used for regulating the common voltage downwardly, and sending the regulated common voltage to the output module 24. The output module 24 is used for outputting the regulated common voltage to the liquid crystal display panel 3.

With the switching module 21, switching between the upward regulating module 22 and the downward regulating module 23 can be achieved, which facilitates subsequent regulation of the common voltage of the liquid crystal display panel 3 by means of the upward regulating module 22 or the downward regulating module 23.

In some embodiments, the correction unit 1 may further include a recording module 15 and a comparison module 18. The recording module 15 is used for recording the flicker value under the control of the control module 16 when the determination result of the determining module 14 is negative, in other words, the control module 16 is further used for controlling the recording module 15 to record the flicker value. The comparison module 18 is used for comparing a deviation of a re-detected flicker value from the flicker value acceptable range with a deviation of the previously-detected flicker value recorded by the recording module 15 from the flicker value acceptable range, and sending a comparison result to the determining module 14, when the determining module 14 determines that the re-detected flicker value, which is detected by the detecting element 13 after the liquid crystal display panel 3 has received the regulated common voltage from the output module 24, is still out of the flicker value acceptable range.

The determining module 14 is further used for determining, according to the comparison result, whether the re-detected flicker value is better than the previously-detected flicker value, and sending a determination result to the control module 16, and the control module 16 is further used for sending a switch control signal to the switch module 21 when the determination result is negative. The switch module 21 is further used for switching from the current upward regulating module 22 to the downward regulating module 23, or switching from the current downward regulating module 23 to the upward regulating module 22, under the control of the switch control signal. If the deviation of the re-detected flicker value from the flicker value acceptable range is smaller than that of the previously-detected flicker value recorded by the recording module 15 from the flicker value acceptable range, the determining module 14 determines that the re-detected flicker value is better than the previously-detected flicker value; if the deviation of the re-detected flicker value from the flicker value acceptable range is larger than that of the previously-detected flicker value recorded by the recording module 15 from the flicker value acceptable range, the determining module 14 determines that the re-detected flicker value is not better than the previously-detected flicker value.

With the comparison module 18, the recording module 15, the determining module 14 and the switch module 21, the regulating system can regulate the common voltage of the liquid crystal display panel 3 more effectively, so that the common voltage of the liquid crystal display panel 3 can fall into the flicker value acceptable range after being automatically regulated.

In some embodiments, the regulating unit 2 may be a digital common voltage regulating chip arranged outside the liquid crystal display panel 3, or a common voltage control register arranged in a source driving chip. Both the digital common voltage regulating chip and the common voltage control register can perform digital regulation on the common electrode of the liquid crystal display panel 3, so that the regulating unit 2 can automatically regulate the common voltage of the liquid crystal display panel 3 under the automatic control of the correction unit 1, which improves not only regulating efficiency but also regulating accuracy.

Based on the above regulating system, embodiments of the present disclosure further provide a regulating method for regulating a common voltage of a liquid crystal display panel, including steps of: detecting a flicker value of the liquid crystal display panel; determining whether the flicker value satisfies a requirement; regulating the common voltage according to a determination result, and providing the regulated common voltage to the liquid crystal display panel.

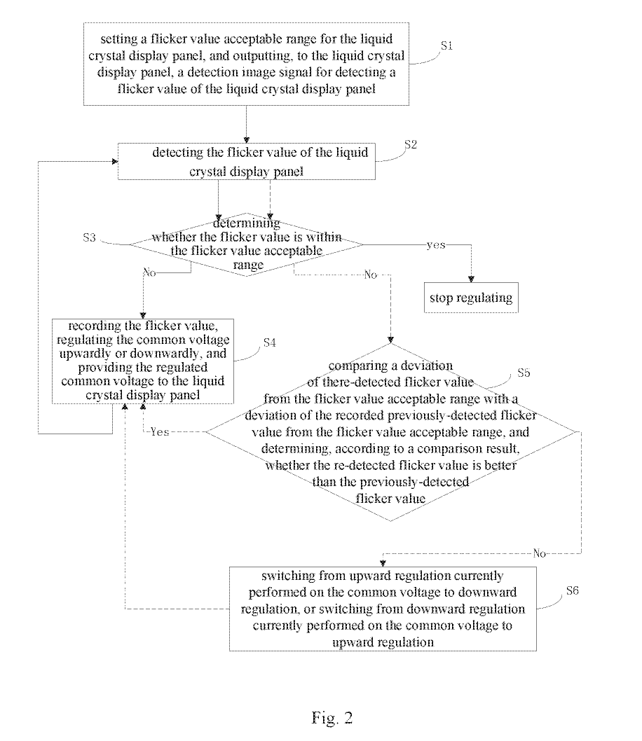

As shown in FIG. 2, the regulating method may include steps as follows.

At step S1, a flicker value acceptable range for the liquid crystal display panel is set, and a detection image signal for detecting the flicker value of the liquid crystal display panel is outputted to the liquid crystal display panel to cause the liquid crystal display panel to display a detection image.

In this step, when a terminal user of the liquid crystal display panel needs to regulate the flicker value of the liquid crystal display panel, it is necessary to set the flicker value acceptable range first and cause the liquid crystal display panel to display the detection image.

At step S2, the flicker value of the liquid crystal display panel is detected.

Before this step, the method may further include: sending a reminder signal of detecting a to-be-detected position of the liquid crystal display panel. Then, in step S2, a detecting personnel places a detecting pen at the to-be-detected position of the liquid crystal display panel upon receipt of the reminder signal. In general, the to-be-detected position is the display center of the liquid crystal display panel. The flicker value at the same position is detected every time.

At step S3, it is determined whether the flicker value is within the flicker value acceptable range, if yes, stop regulating; if no, proceed to step S4: regulating the common voltage upwardly or downwardly, and providing the regulated common voltage to the liquid crystal display panel.

In some embodiments, step S4 further includes: recording the flicker value, and then return back to step S2. In this case, steps S2 and S3 are performed again after performing step S4, and if a re-detected flicker value is still out of the flicker value acceptable range, proceed to step S5: comparing a deviation of the re-detected flicker value from the flicker value acceptable range with a deviation of the recorded previously-detected flicker value from the flicker value acceptable range, and determining, according to a comparison result, whether the re-detected flicker value is better than the previously-detected flicker value, if yes, proceed to step S4, and then return back to step S2; if no, proceed to step S6: switching from upward regulation currently performed on the common voltage to downward regulation, or switching from downward regulation currently performed on the common voltage to upward regulation, then proceed to step S4, and then return back to step S2.

If the deviation of the re-detected flicker value from the flicker value acceptable range is smaller than that of the previously-detected flicker value from the flicker value acceptable range, it is determined that the re-detected flicker value is better than the previously-detected flicker value; otherwise, it is determined that the re-detected flicker value is not better than the previously-detected flicker value.

For example, after a regulation begins, the flicker value acceptable range for the liquid crystal display panel is set to be lower than −30 db. The flicker value of the liquid crystal display panel obtained in the first detection is −15 db, which is beyond the flicker value acceptable range; the flicker value is recorded, meanwhile, it is assumed that the common voltage is regulated by the amplitude of 0.005V each time, and the common voltage is regulated upwardly by 0.005V; next, the flicker value of the liquid crystal display panel obtained in the next detection is −11 db; the deviation of the flicker value obtained in the first detection (i.e., previously-detected flicker value) from the flicker value acceptable range is compared with the deviation of the flicker value obtained in the next detection (i.e., re-detected flicker value) from the flicker value acceptable range, obviously, the flicker value obtained in the next detection is not better than that obtained in the first detection, and therefore, the common voltage is regulated downwardly by 0.005V, and so on until the detected flicker value is within the flicker value acceptable range (i.e., lower than −30 db), and the regulation is completed by then.

With the above regulating method, a common voltage of the liquid crystal display panel can be regulated more effectively, as a result, regulating efficiency of the common voltage of the liquid crystal display panel is greatly improved, and meanwhile regulating accuracy is improved as well.

In the regulating system provided by the present disclosure, with the correction unit and the regulating unit, the regulating system can automatically regulate the common voltage of the liquid crystal display panel, so that flicker phenomenon, due to drift in characteristics of the liquid crystal display panel, is alleviated or avoided, and image quality is improved; meanwhile, compared to the prior art, regulating efficiency and regulating quality of the common voltage of the liquid crystal display panel are improved as well.

Embodiments of the present disclosure further disclose a display device including the above described regulating system.

By adopting the above described regulating system, automatic regulation of common voltage in the display device is achieved, as a result, flicker phenomenon, due to drift in characteristics of the liquid crystal display panel in the display device, is alleviated or avoided, and display quality of the display device is improved.

The display device provided by the present disclosure may be any product or component having a liquid crystal display function such as a liquid crystal display panel, a liquid crystal television, a display, a mobile phone, a navigator or the like.

It could be understood that the above implementations are merely exemplary implementations adopted for describing the principle of the disclosure, but the disclosure is not limited thereto. Various variations and improvements may be made by those of ordinary skill in the art without departing from the spirit and essence of the disclosure, and these variations and improvements shall also be regarded as falling into the protection scope of the disclosure.

1. A regulating system for regulating a common voltage of a liquid crystal display panel, comprising a correction unit and a regulating unit, wherein the correction unit is used for detecting a flicker value of the liquid crystal display panel, determining whether the flicker value satisfies a requirement, and sending a regulating control signal to the regulating unit according to a determination result; and the regulating unit is used for regulating the common voltage according to the regulating control signal and providing the regulated common voltage to the liquid crystal display panel.

2. The regulating system according to claim 1, wherein the correction unit comprises a setting module, a detection image output module, a detecting element, a determining module and a control module,
the setting module is used for setting a flicker value acceptable range for the liquid crystal display panel;
the detection image output module is used for outputting, to the liquid crystal display panel, a detection image signal for detecting the flicker value of the liquid crystal display panel to cause the liquid crystal display panel to display a detection image;
the detecting element is used for detecting the flicker value of the liquid crystal display panel, and sending the flicker value to the determining module;
the determining module is used for determining whether the flicker value is in the flicker value acceptable range and sending the determination result to the control module; and
the control module is used for sending the regulating control signal to the regulating unit when the determination result of the determining module is negative.

3. The regulating system according to claim 2, wherein the correction unit further comprises a reminder module, used for sending, under the control of the control module, a reminder signal of placing the detecting element at a to-be-detected position of the liquid crystal display panel after the detection image output module has outputted the detection image signal to the liquid crystal display panel.

4. The regulating system according to claim 3, wherein the regulating unit comprises a switch module, an upward regulating module, a downward regulating module and an output module,
the switch module is used for switching between the upward regulating module and the downward regulating module upon receipt of the regulating control signal;
the upward regulating module is used for regulating the common voltage upwardly, and sending the regulated common voltage to the output module;
the downward regulating module is used for regulating the common voltage downwardly, and sending the regulated common voltage to the output module; and
the output module is used for outputting the regulated common voltage to the liquid crystal display panel.

5. The regulating system according to claim 4, wherein the correction unit further comprises a recording module and a comparison module, the recording module is used for recording the flicker value under the control of the control module when the determination result of the determining module is negative; and the comparison module is used for comparing a deviation of a re-detected flicker value detected by the detecting element after the liquid crystal display panel has received the regulated common voltage outputted from the output module from the flicker value acceptable range with a deviation of a previously-detected flicker value recorded by the recording module from the flicker value acceptable range, and sending a comparison result to the determining module, when the determining module determines that the re-detected flicker value is still out of the flicker value acceptable range;
the determining module is further used for determining, according to the comparison result, whether the re-detected flicker value is better than the previously-detected flicker value, and sending a determination result to the control module, and the control module is further used for sending a switch control signal to the switch module when the determination result is negative; and
the switch module is used for switching from the current upward regulating module to the downward regulating module, or switching from the current downward regulating module to the upward regulating module, under the control of the switch control signal.

6. The regulating system according to claim 5, wherein the regulating unit is a digital common voltage regulating chip arranged outside the liquid crystal display panel, or a common voltage control register arranged in a source driving chip.

7. A regulating method for regulating a common voltage of a liquid crystal display panel, comprising steps of: detecting a flicker value of the liquid crystal display panel; determining whether the flicker value satisfies a requirement; regulating the common voltage according to a determination result, and providing the regulated common voltage to the liquid crystal display panel.

8. The regulating method according to claim 7, wherein the regulating method comprises:
step S1: setting a flicker value acceptable range for the liquid crystal display panel, and outputting, to the liquid crystal display panel, a detection image signal for detecting the flicker value of the liquid crystal display panel to cause the liquid crystal display panel to display a detection image;
step S2: detecting the flicker value of the liquid crystal display panel; and
step S3: determining whether the flicker value is within the flicker value acceptable range, if yes, stop regulating; if no, proceed to step S4: regulating the common voltage upwardly or downwardly, and providing the regulated common voltage to the liquid crystal display panel.

9. The regulating method according to claim 8, wherein between step S1 and step S2, the regulating method further comprises: sending a reminder signal of detecting a to-be-detected position of the liquid crystal display panel.

10. The regulating method according to claim 8, wherein step S4 further comprises:
recording the flicker value, and after performing step S4, return back to step S2 to perform steps S2 and S3 again, if it is determined that a re-detected flicker value is still out of the flicker value acceptable range, proceed to step S5: comparing a deviation of the re-detected flicker value from the flicker value acceptable range with a deviation of the recorded previously-detected flicker value from the flicker value acceptable range, and determining, according to a comparison result, whether the re-detected flicker value is better than the previously-detected flicker value, if yes, proceed to step S4, and then return back to step S2; if no, proceed to step S6: switching from upward regulation currently performed on the common voltage to downward regulation, or switching from downward regulation currently performed on the common voltage to upward regulation, then proceed to step S4, and next return back to step S2.

11. The regulating method according to claim 10, wherein, if the deviation of the re-detected flicker value from the flicker value acceptable range is smaller than that of the previously-detected flicker value from the flicker value acceptable range, it is determined that the re-detected flicker value is better than the previously-detected flicker value; otherwise, it is determined that the re-detected flicker value is not better than the previously-detected flicker value.

12. A display device, comprising a regulating system for regulating a common voltage of a liquid crystal display panel, wherein the regulating system comprises a correction unit and a regulating unit, the correction unit is used for detecting a flicker value of the liquid crystal display panel, determining whether the flicker value satisfies a requirement, and sending a regulating control signal to the regulating unit according to a determination result; and the regulating unit is used for regulating the common voltage according to the regulating control signal and providing the regulated common voltage to the liquid crystal display panel.

13. The display device according to claim 12, wherein the correction unit comprises a setting module, a detection image output module, a detecting element, a determining module and a control module,
the setting module is used for setting a flicker value acceptable range for the liquid crystal display panel;
the detection image output module is used for outputting, to the liquid crystal display panel, a detection image signal for detecting the flicker value of the liquid crystal display panel to cause the liquid crystal display panel to display a detection image;
the detecting element is used for detecting the flicker value of the liquid crystal display panel, and sending the flicker value to the determining module;
the determining module is used for determining whether the flicker value is in the flicker value acceptable range and sending the determination result to the control module; and
the control module is used for sending the regulating control signal to the regulating unit when the determination result of the determining module is negative.

14. The display device according to claim 13, wherein the correction unit further comprises a reminder module, used for sending, under the control of the control module, a reminder signal of placing the detecting element at a to-be-detected position of the liquid crystal display panel after the detection image output module has outputted the detection image signal to the liquid crystal display panel.

15. The display device according to claim 14, wherein the regulating unit comprises a switch module, an upward regulating module, a downward regulating module and an output module,
the switch module is used for switching between the upward regulating module and the downward regulating module upon receipt of the regulating control signal;
the upward regulating module is used for regulating the common voltage upwardly, and sending the regulated common voltage to the output module;
the downward regulating module is used for regulating the common voltage downwardly, and sending the regulated common voltage to the output module; and
the output module is used for outputting the regulated common voltage to the liquid crystal display panel.

16. The display device according to claim 15, wherein the correction unit further comprises a recording module and a comparison module, the recording module is used for recording the flicker value under the control of the control module when the determination result of the determining module is negative; and the comparison module is used for comparing a deviation of a re-detected flicker value detected by the detecting element after the liquid crystal display panel has received the regulated common voltage outputted from the output module from the flicker value acceptable range with a deviation of a previously-detected flicker value recorded by the recording module from the flicker value acceptable range, and sending a comparison result to the determining module, when the determining module determines that the re-detected flicker value is still out of the flicker value acceptable range;
the determining module is further used for determining, according to the comparison result, whether the re-detected flicker value is better than the previously-detected flicker value, and sending a determination result to the control module, and the control module is further used for sending a switch control signal to the switch module when the determination result is negative; and
the switch module is used for switching from the current upward regulating module to the downward regulating module, or switching from the current downward regulating module to the upward regulating module, under the control of the switch control signal.

17. The display device according to claim 16, wherein the regulating unit is a digital common voltage regulating chip arranged outside the liquid crystal display panel, or a common voltage control register arranged in a source driving chip.
